(19) United States
(12) Patent Application Publication
(10) Pub. No.: US 2006/0168046 A1
(43) Pub. Date: Jul. 27, 2006

(54) Managing periodic electronic messages

(75) Inventor: Imran I. Qureshi, Milpitas, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporaion, Redmond, WA (US)

(21) Appl. No.: 11/034,514

(22) Filed: Jan. 11, 2005

(51) Int. Cl. G06F 15/16

(52) U.S. Cl. 709/206

(57) ABSTRACT

Management of periodic electronic messages received from a sender. Managing periodic messages includes reducing the number of stale and/or obsolete messages maintained in the user's account. A periodic message can be identified if the sender of the message is listed in a periodic mail rules list or by processing previously received electronic messages. One or more rules can be generated to process periodic messages from periodic message sources. The one or more rules can be applied to subsequent incoming messages and/or stored messages.

### BACKGROUND OF THE INVENTION

1. Field of the Invention

The present invention is directed to managing electronic messages.

2. Description of the Related Art

Email users receive email from a growing number of sources. These sources include friends, family, professional associates, mailing list administrators, creditors, web services, advertisers, spammers and other sources. Some of these sources send email to a user periodically at regular intervals. For example, a user may receive monthly bank and other financial statements, account information from a department store, and sales information from a retail business or web service. In most cases, periodic emails are only useful for a limited time. Typically, a subsequent email is received from the sender that includes an update to the information provided in the earlier email. The updated information may include an updated balance for an account, updated sale information for a business, or other information that typically replaces the information in the previous email. The subsequent email with updated information renders the previous email stale and/or expired.

Users typically do not delete periodic emails upon receiving them because they contain time-sensitive information. As a result, previously received periodic emails are maintained in storage and made obsolete when the next periodic email from the sender is received. After a period of time, the number of obsolete periodic emails stored for a user account increases.

Sifting through a large number of stored periodic emails to determine which are obsolete can be a tedious task and makes management of an email account difficult. Email account management can be complicated even further when a user wishes to handle periodic emails from varying sources in different ways. Some current email systems allow a user to implement rules to block emails or route emails to a folder based on the sender or key words in the email. Management of periodic emails is useful to users managing email accounts and systems providing space to store emails.

### SUMMARY OF THE INVENTION

The technology herein, roughly described, manages periodic or regularly received electronic messages received for a message recipient. Managing periodic messages reduces the number of stale and/or obsolete messages stored in the user's account and reduces the time required by users to scan and find messages. A method for managing electronic messages begins with accessing one or more electronic messages sent to a recipient from a sender. After accessing the one or more messages, a determination is made as to whether the one or more electronic messages are periodic electronic messages. If electronic messages are detected or identified as periodic messages, a rule is generated for retaining future electronic messages from the sender for the recipient. The rule is based on the one or more electronic messages.

In another embodiment, a system can process periodic email. The system may include an email access device, a rule generator and an email management device. The email management is connectively coupled to the email access device and the rule generator. The email access device can access one or more emails sent from a sender and to a recipient. The email access device may also identify periodic email. The rule generator can generate a rule for processing periodic email. The rule generator derives the rule from the one or more emails accessed by the recipient from a sender. The email management device is configured to apply the generated rule to one or more periodic emails received by the recipient from a sender.

### BRIEF DESCRIPTION OF THE DRAWINGS

FIG. 1A illustrates one embodiment of a web-based system for implementing the present invention.

FIG. 1B illustrates one embodiment of a client-based system for implementing the present invention.

FIG. 1C illustrates one embodiment of an enterprise-based system for implementing the present invention.

FIG. 2 illustrates one embodiment of a computing environment for use with the present invention.

FIG. 3 illustrates one embodiment of a method for managing periodic mailings.

FIG. 4 illustrates one embodiment of a method for determining an electronic message is a periodic message.

FIG. 5 illustrates one embodiment for generating a rule for processing a periodic message from a source.

FIG. 6 illustrates one embodiment of an interface for prompting a user to apply a rule to an electronic message.

FIG. 7 illustrates one embodiment of an interface for generating a periodic mailing rule.

FIG. 8 illustrates one embodiment of a method for applying a rule to an incoming message.

FIG. 9 illustrates one embodiment of a method for applying a rule to stored electronic messages.

### DETAILED DESCRIPTION

Systems and methods are disclosed for managing periodic electronic messages received by a message recipient. A periodic electronic message is one of a series of messages sent by a sender to a recipient at a specific time interval. Periodic electronic messages can include email and other types of digital messages that can be received and stored. Managing periodic messages, or periodic emails, includes reducing the number of stale and/or obsolete messages stored in a user's account. A stale message is any of a series of messages from a sender that is not the most recently received message.

Emails can be detected and/or identified as periodic by processing each message individually. In one embodiment, if the sender of a received email matches a sender listed in a periodic mail rules list, the received email is identified as periodic mail. A periodic mail rules list is a list of one or more senders of periodic mail. Rules can be applied to emails received from senders listed on the periodic mail rules list. The periodic mail rules list can be generated from user input, processing of stored emails, submission by legitimate periodic mail senders or in some other manner. In one embodiment, a periodic mail rules list may also include one or more rules to apply to an email received from a particular sender. In some embodiments, rules to be applied to senders listed in the periodic mail rules list are stored in a separate look-up table. Periodic mail rules lists are discussed in more detail below.

An email can also be identified as periodic by analyzing the received email in combination with the other stored emails from the sender in the user's account. In one embodiment, if the average time interval between the received email and stored emails from a sender matches a specific interval value, the received email, stored emails and subsequently received emails from the sender are identified as periodic emails.

Once an email from a sender is identified as a periodic email, one or more rules can be generated to process email from the sender. The one or more rules can be applied to subsequently received emails and/or stored emails. The rules are stored in a rule table within an email system that processes the emails.

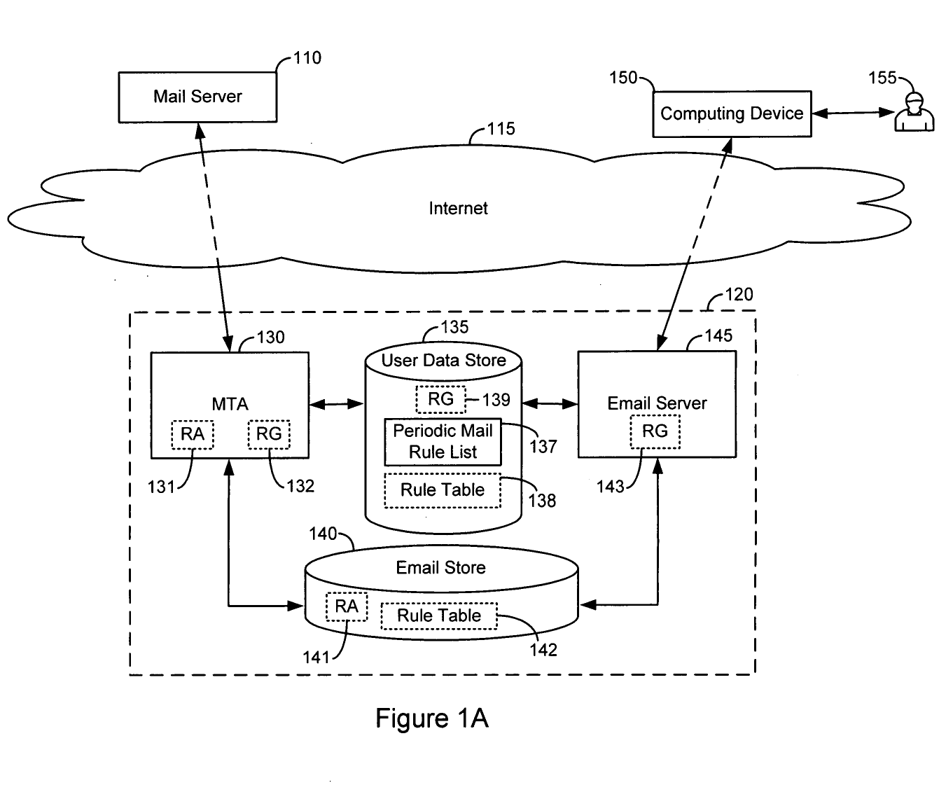

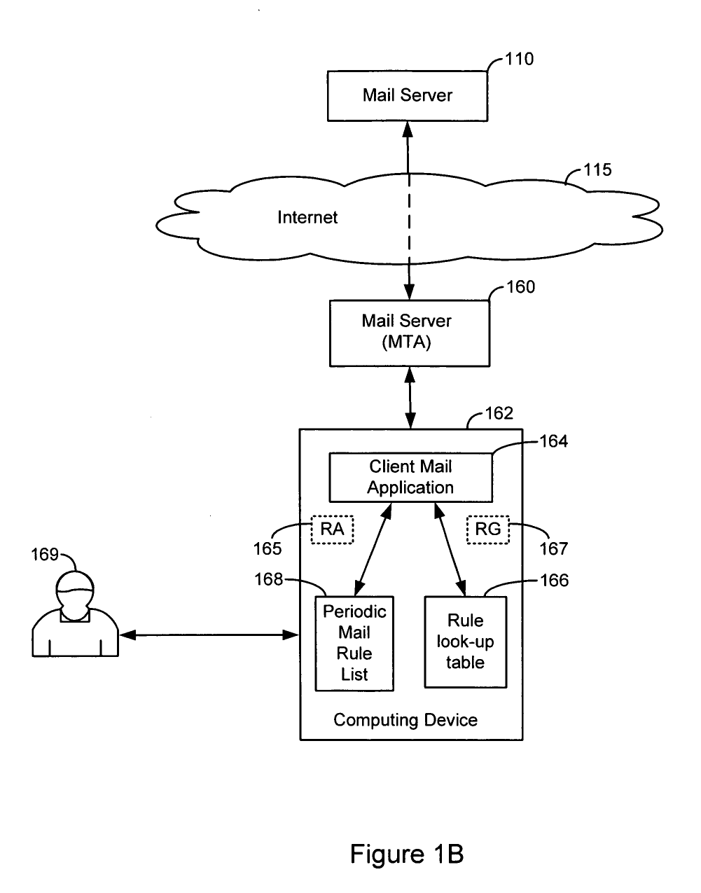

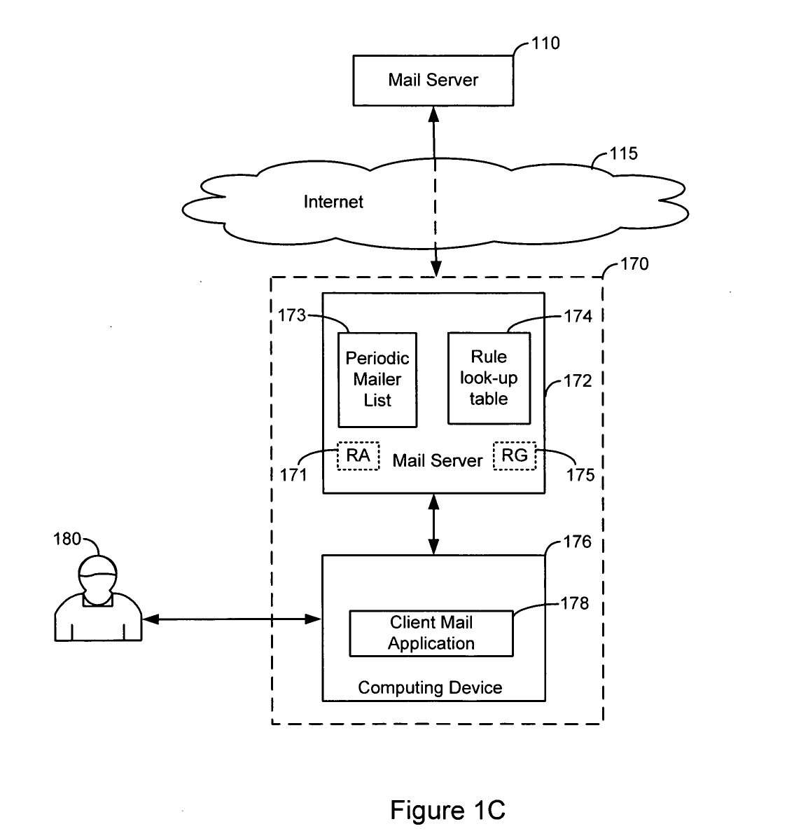

The present invention can be implemented by a web-based email system, a client-based email system and an enterprise-based email system. Each of these systems can receive, identify and manage and/or process periodic emails. An embodiment of these systems is illustrated in FIGS. 1A-C, respectively, and discussed in more detail below.

FIG. 1A illustrates one embodiment of a web-based email system for processing periodic emails. Web-based system 120 of FIG. 1A may be provided by an email service provider (ESP) 120. System 120 includes mail transfer agent (MTA) 130, user data store 135, email store 140 and email server 145. User data store 135 includes periodic mail rules list 137 and may include rule table 138. Email store 140 may include rule table 142. Rule tables 138 and 142 may be instances of the same rule table or different rule tables. When different, each may include rules applied by the system component they are respectively stored in. System 120 provides a web-based email service over Internet 115 to one or more users, such as user 155. System 120 receives emails for a user 155 from mail server 110 through Internet 115. MTA 130 receives incoming email within system 120. Once received, the email is stored in email store 142. User 155 can access emails by logging in to system 120 through an interface provided to computing device 150 by email server 145. In one embodiment, an application such as a web browser can provide an interface, such as a web page, to access system 120.

System 120 may also include one or more periodic rule generation engines (RG) and a periodic rule application engines (RA). An RG may generate a rule to apply to a periodic email. An RA may apply a rule or perform an action based on a rule to an email. For example, MTA 130 includes RA 131 and RG 132. RA 131 of MTA 130 may perform actions to incoming email based on periodic email processing rules. To process incoming emails, MTA 130 can access periodic mail rules list 137 and, in embodiments where mail processing rules are stored separately from the periodic mail rules list, periodic email rules from rule table 138 stored in user data store 135. Email store 140 may include RA 141. RA 141 of mail store 140 can perform actions on stored periodic email based on periodic email processing rules. To process stored emails, periodic email rules are accessed from rule table 142. Email store 145 may include RG 143. RG 143 can generate periodic mail processing rules and send the rules to user data store 135 and email store 140. User data store may include RG 139 which generates periodic mail rules from information received from MTA 130 and email server 145. Periodic mail processing by a web-based email system is discussed in more detail below.

FIG. 1B illustrates one embodiment of a client-based email system for processing periodic emails. The client-based system of FIG. 1B includes computing device 162, which includes client mail application 164, rule look-up table 166 and periodic mail rules list 168. Client mail application 164, rule look-up table 166 and periodic mail rules list 168 can be stored in memory of computing device 162, discussed in more detail below. An email for a user 169 is sent by mail server 110 through Internet 115 to mail server 160. In one embodiment, mail server 160 is implemented as a mail transfer agent. User 169 may access the email stored on mail server 160 using client mail application 164. For example, a user initiates a connection between client mail application 164 and mail server 160. Once the connection is established, a user may access emails stored in mail server 160 for the user's account.

Client mail application 164 may perform actions on emails stored in mail server 160. Client mail application 164 can also identify an email as periodic using periodic mail rules list 168. The actions can be based on rules accessed from periodic mail rules list 168 or, in embodiments where mail processing rules are stored separately from the periodic mail rules list, rule look-up table 166. Actions performed on emails include processing new emails and old emails. In one embodiment, a new email is an email that has been received by mail server 160 since the last time a user accessed mail server 160. An old email is an email that has been accessed and stored for a user.

In one embodiment, computing device 162 may include RA 165 and RG 167. RG 167 can generate rules to be applied to periodic mails stored in mail server 160. RA 165 may apply rules to email stored in mail server 160. Periodic mail processing by a client-based email system is discussed in more detail below.

FIG. 1C illustrates one embodiment of an enterprise-based email system for processing periodic emails. The enterprise-based system of FIG. 1C includes enterprise system 170, which includes mail server 174 and computing device 176. Mail server 174 includes periodic mail rules list 173 and rule look-up table 174. Computing device 176 includes client mail application 178. In one embodiment, client mail application 178 is stored in memory of computing device 176, discussed in more detail below. An email for a user 180 is sent by mail server 110 through Internet 115 to enterprise system 170. Mail server 172 within enterprise system 170 receives and stores the email for the user. User 180 may access the email stored on mail server 172 using client mail application 178. For example, user 180 initiates a connection between client mail application 178 and mail server 172. Once the connection is established, user 180 may access emails stored in mail server 172 for the user's account.

Mail server 172 may identify and perform actions on incoming and received periodic email. Periodic mail rules list 173 is accessed to identify emails received from periodic email senders. The actions performed on emails are based on rules accessed from periodic mail rules list 173 or, in embodiments where mail processing rules are stored separately from the periodic mail rules list, rule look-up table 174.

In one embodiment, mail server 172 may include RA 171 and RG 175. RG 175 can generate rules to be applied to periodic mails stored in mail server 172. RA may apply rules to email stored in mail server 171. Periodic mail processing by an enterprise-based email system is discussed in more detail below.

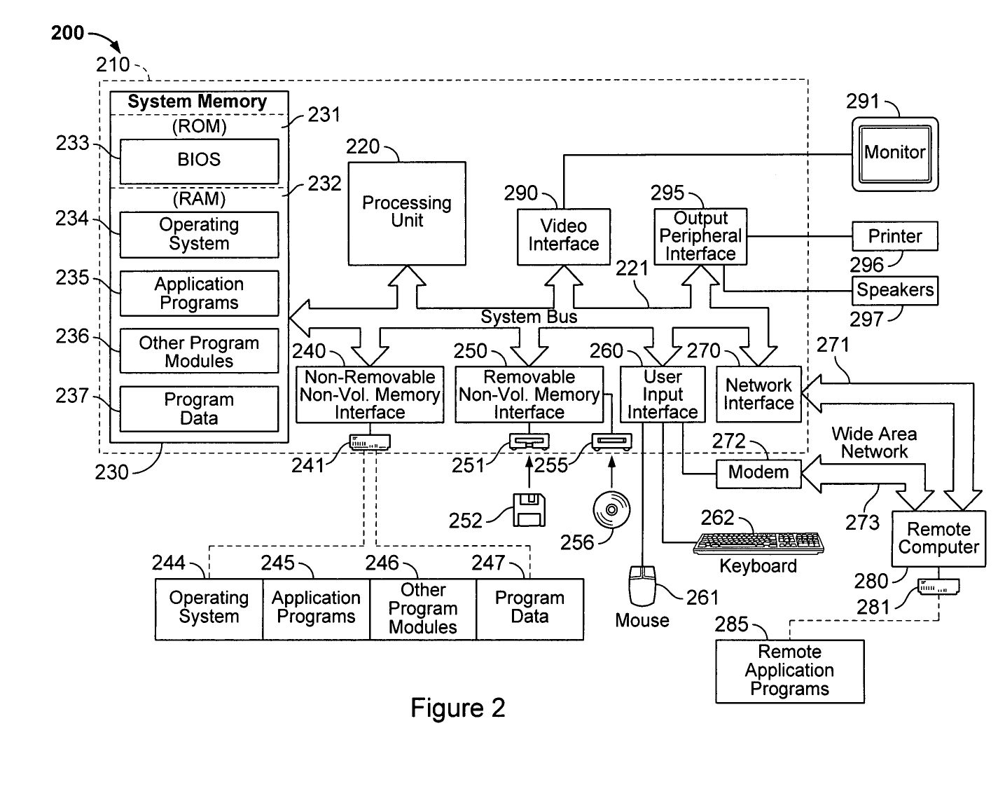

FIG. 2 illustrates one embodiment of a computing environment for use with the present invention. In one embodiment, the computing environment can be used to implement the servers and computing devices illustrated in FIGS. 1A-1C.

FIG. 2 illustrates an example of a suitable computing system environment 200 on which the invention may be implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the invention includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through an non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through a output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

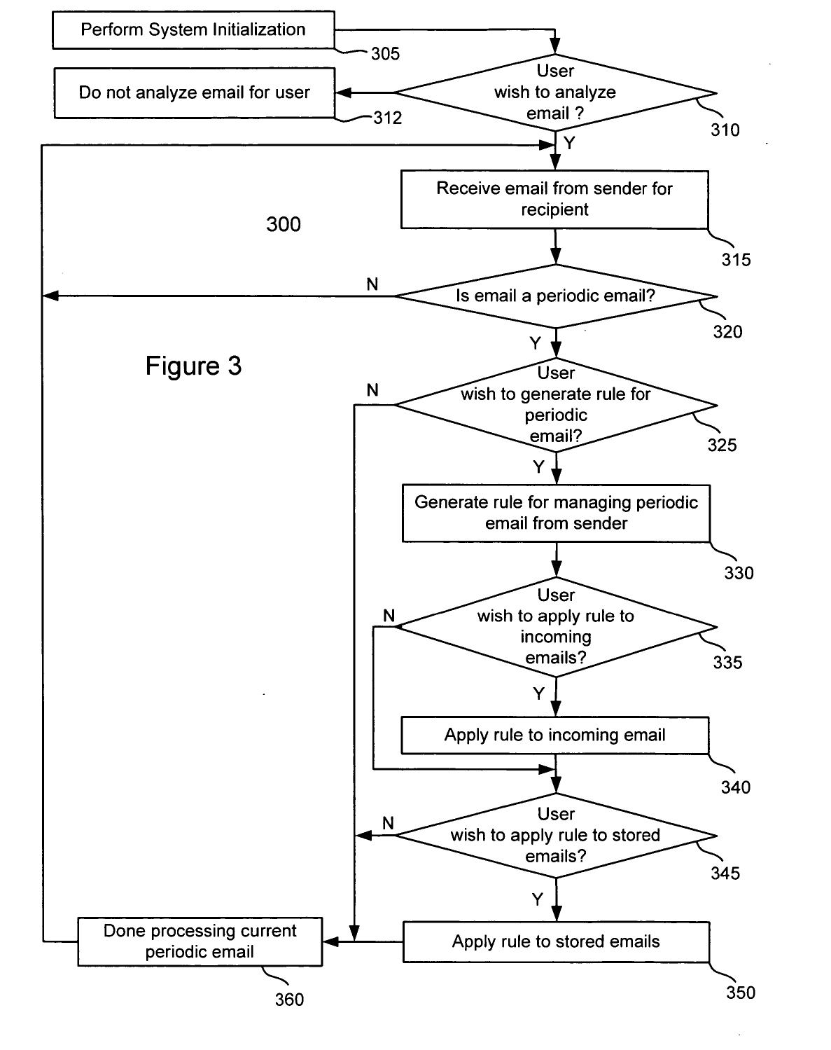

FIGS. 3-5 and 8-9 illustrate embodiments of methods for identifying and processing periodic emails. ESP system 120, client based system of computing device 162, and enterprise system 170 can all perform each of these methods. Thus, when a system is referred to as performing a step in a method or the entire method of FIGS. 3-5 and 8-9 in the discussion below, it is intended that any of the three types of systems can perform the step or method.

FIG. 3 illustrates one embodiment of a method 300 for managing periodic mailings. System initialization is performed at step 305. In one embodiment, system initialization includes logging into an email system. Next, a user is queried to indicate whether the user wishes to have email analyzed for periodic email at step 310. The query can be done in several ways, including when the user first accesses an email, when the user first accesses an email account, or in some other manner depending on design preference. If the user indicates that email should not be analyzed at step 310, then operation continues to step 312 where the system will not analyze user email. If the user wishes for email to be analyzed, operation continues to step 315.

An email is received from a sender for a recipient at step 315. Next, the system determines whether the received email is a periodic email at step 320. If the email is identified as a periodic email, operation continues to step 325. If the email is identified as a non-periodic email, operation returns to step 315 where the system awaits the next email.

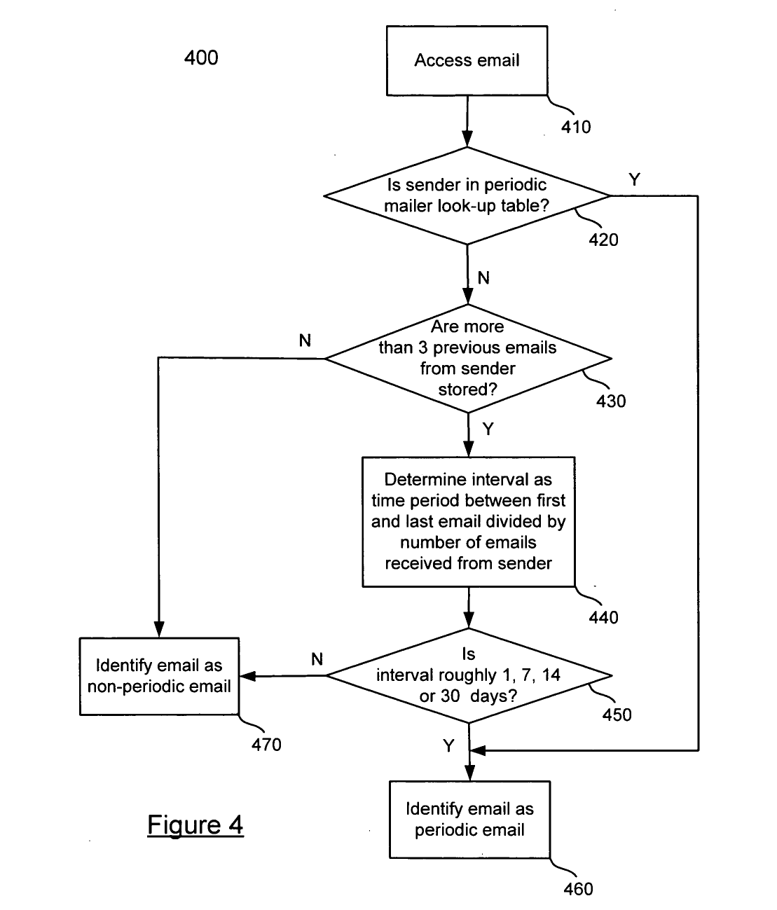

The step of identifying the received email as periodic email can be performed in a variety of ways. In one embodiment, a system of the present invention may determine the email is periodic by analyzing the received email and stored emails from the same sender. For example, emails from senders that are in a periodic mail sender list would be marked as periodic. In another embodiment, a user may provide input indicating that the received email is a periodic email. In yet another embodiment, the received email can be analyzed individually to determine whether it is periodic. For example, the incoming email may be marked with periodic email information by the sender. In this case, a bit can be set or tagged by the sender indicating whether or not the email is periodic email. Periodic mail “tagging” by a sender may make a recipient more likely to sign up for a periodic mail if the recipient knows the email will be automatically managed. Identifying an email as periodic email at step 320 is discussed in more detail below with respect to FIG. 4.

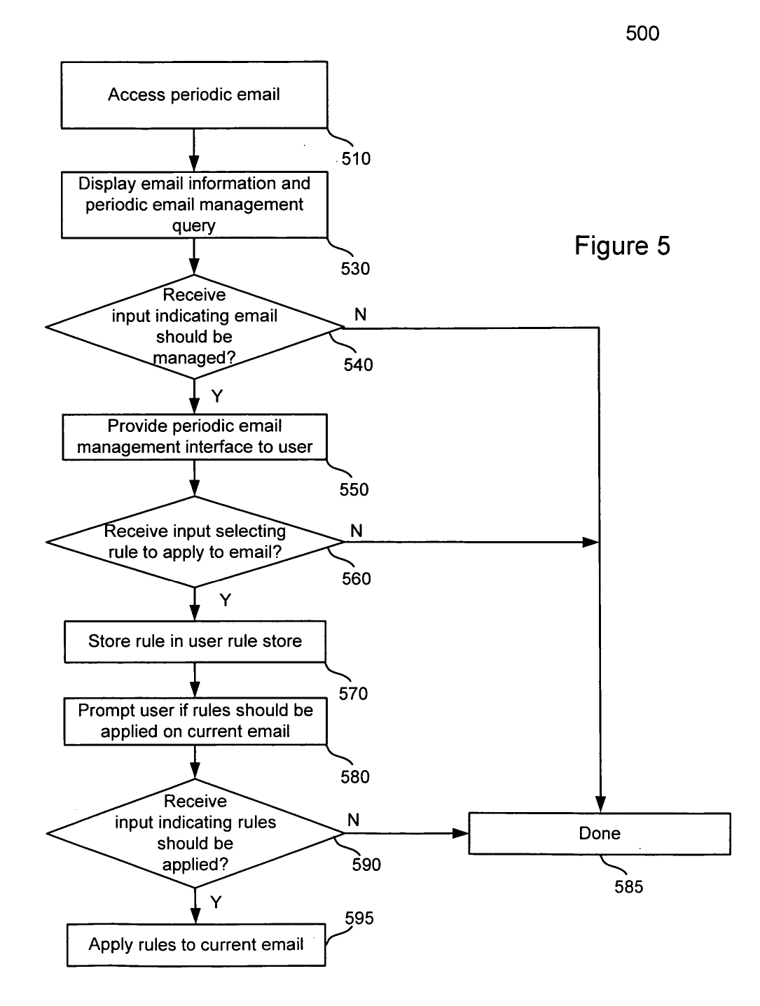

A user is queried to indicate whether a rule should be generated for the periodic email at step 325. If the user indicates a rule should not be generated for the periodic email, operation continues to step 360. If the user indicates a rule should be generated, a rule is generated regarding the periodic email received from the sender at step 330. Generation of a rule can be done automatically or from user input. When rule generation is performed automatically, operation continues from step 320 to 330. Generating a rule for managing periodic emails as in step 330 is discussed in more detail below with respect to FIG. 5.

After generating a rule, a user is queried to indicate whether the rule should be applied to incoming email at step 335. If the user indicates the rule should not be applied to incoming email, operation continues to step 345. If the user indicates a rule should be applied to incoming email, operation continues to step 340. In one embodiment, applying a rule to email may performed based on a user controlled setting. If the user indicates that the rule should be applied automatically, then operation continues from step 330 to step 340.

The generated rule is applied to incoming emails at step 340. Different systems can apply the rule to incoming email in different ways. In ESP 120 of FIG. 1A, the rule is applied to incoming emails by MTA 130. In the client-based system utilizing computing device 162 of FIG. 1B, the rule is applied to incoming emails by client mail application 164. In this embodiment, the rule is applied by client mail application 164 to new emails when the user accesses mail server 160. In enterprise system 170, the rule is applied to incoming emails by email server 174. Applying a rule to incoming emails is discussed in more detail below.

Next, a user is queried to indicate whether the rule should be applied to stored emails at step 345. If the user indicates rule should not be applied to stored email, operation continues to step 360. If the user indicates a rule should be applied to stored email, operation continues to step 350.

The rule is applied to stored emails at step 350. Different email systems can be configured to apply the rule to stored email in different ways. In ESP 120 of FIG. 1A, the rule is applied to stored emails by email store 140. In the client-based system utilizing computing device 162 of FIG. 1B, the rule is applied to stored emails by client mail application 164. In this embodiment, the rule is applied by client mail application 164 to stored emails each time the user accesses mail server 160. In enterprise system 170, the rule is applied to incoming emails by email server 174. Applying a rule to generated emails is discussed in more detail below.

FIG. 4 illustrates one embodiment of a method for determining an email is a periodic email as discussed above at step 320 of method 300. An email is accessed at step 410. The email may be a new email or a stored email. After accessing the email, it is determined whether the sender of the email is listed in a periodic mail rules list at step 420. To make this determination, the sender of the accessed email is compared to every sender listed in the periodic mail rules list. If the sender of an email is not listed in a periodic mail rules list, the operation continues to step 430. If the sender is listed in the periodic mail rules list, the operation continues to step 460 where the email is identified as a periodic email.

Next, the system determines whether the sender has sent previous emails to the recipient. At step 430, the system determines whether more than three previous emails from the sender of the accessed email are stored. If less than three previous emails from the sender are found, operation continues to step 470 where the email is identified as a non-periodic email. If three or more emails from the same sender as the accessed email of step 410 are found, operation continues to step 440. If more than three emails are stored, the emails are potentially periodic emails and may require management. In one embodiment, a different number of stored emails can be used at step 430. In another embodiment, information from emails received by a user but subsequently deleted may also be checked to determine if more than a designated number of emails are received from a sender. In this case, information regarding the deleted emails, including the sender, date received, email subject, or other information, is stored before deleting the email. However, at least two emails are preferred to determine an interval between emails received from the sender in the next step

A periodic email is one of a series of emails sent at about the same time interval. To identify periodic emails, the average interval between the time they were received is determined. At step 440, the average interval for the emails from a sender is determined as a time period between the first and last email divided by the number of emails received. This determines the average interval at which an email is received from the sender by the recipient. For example, if a first email is received on the 1st of a month, a second received on the 10th of the month and the third email received on the 15^{th} of the month, all from the same sender, then the average interval is (15−1)/2=14/2=7. In another embodiment, a determination can be made as to the actual day(s) of the week and/or date the emails are received to determine if they are periodic. For example, if a first email was received on Monday and the next two emails are also received on Mondays, the emails are determined to be periodic. As another example, if the first email was received on February 1^{st} and the next emails are received on March 1^{st} and April 1^{st}, the emails are determined to be periodic even though February only has 28 days (thus, the emails are received at different intervals). Additionally, holidays can be taken into account. Thus, if one email is received on December 1^{st} and the next on January 2^{nd}, the emails are determined to be periodic since 1^{st} of January is a holiday.

Periodic emails will typically be sent every day, every week, bimonthly or monthly. Thus, emails having intervals that roughly match these time periods are identified as periodic emails. A determination is made as to whether the email average interval is roughly one, seven, fourteen or thirty days at step 450. In one embodiment, other specific intervals in units of days, hours, weeks, or months can be compared to the average interval at step 450. If the average interval matches one of the specific intervals, operation continues to step 460. If the interval is not one of these values, operation continues to step 470.

In one embodiment, a user or system can set an interval range for determining the average interval of emails received from a sender. For example, an interval range of twenty-eight to thirty-two days will include emails sent from a sender every twenty-nine days (28-32) as well as every thirty days. In one embodiment, intervals for larger number of days have a larger threshold. For example, a seven day periodic interval may have an interval range of plus or minus one day, while a thirty day periodic interval may have an interval range threshold of plus or minus two days.

At step 460, the received email is identified as a periodic email. Information associated with the periodic email can be configured to indicate the email is periodic email. For example, the email can be “tagged” by setting a bit to indicate the email is a periodic email. Additionally, the sender of the email accessed at step 410 is added to the periodic mail rules list.

If less than three previous emails are detected at step 430 or the stored emails do not have an average interval that matches a specific interval or interval range at step 450, the email is identified as a non-periodic email at step 470. In this case, the email can be configured or tagged to indicate the email is non-periodic. In one embodiment, once identified as a non-periodic email, no further periodic email processing is performed on the non-periodic mail. In another embodiment, additional periodic email processing can be performed after the email is identified as non-periodic email if the user tags the email as a periodic mail.

FIG. 5 illustrates one embodiment of a method for generating a rule for processing periodic emails as discussed above at step 330 of method 300. A periodic email is accessed at step 510. In one embodiment, a periodic email may be accessed in response to a request to access an email inbox, a particular email or some other email information.

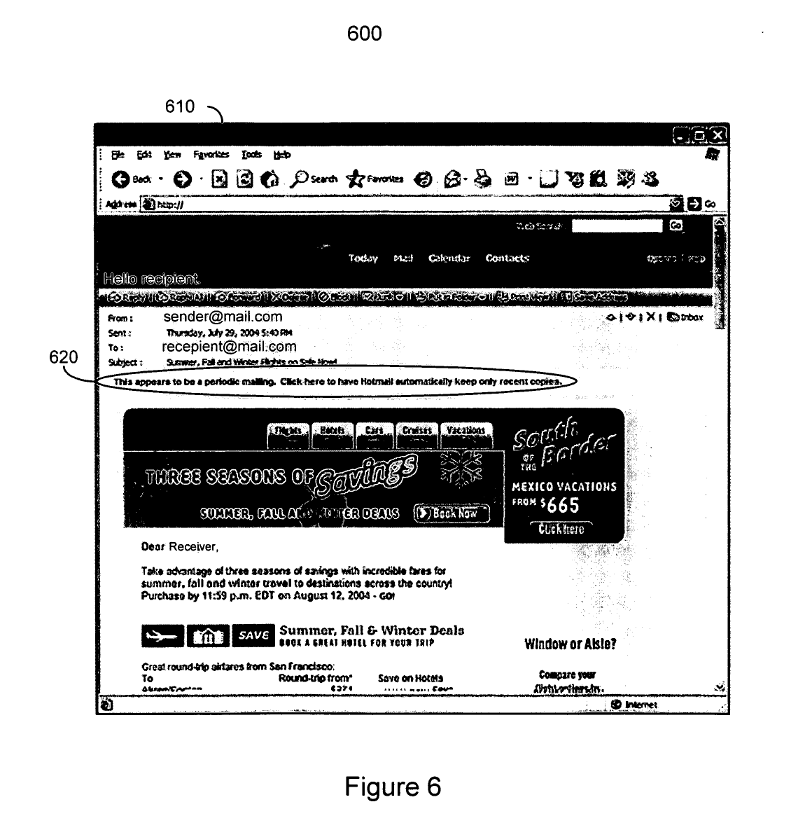

Email information along with an email management query is provided in an interface at step 530. In one embodiment, the interface can be a display of the email to a user in a web browser or a client application. In one embodiment, the email management query prompts the user as to whether the accessed periodic email should be managed. An example of an interface including an email management query for a user is illustrated by interface 600 of FIG. 6. Interface 600 is discussed in more detail below.

At step 540, a determination is made as to whether input is received indicating the periodic email should be managed. If no input is received indicating the email should be managed, operation continues to step 585 where no further periodic email processing is performed. If input is received indicating the email should be managed, then operation continues to step 550.

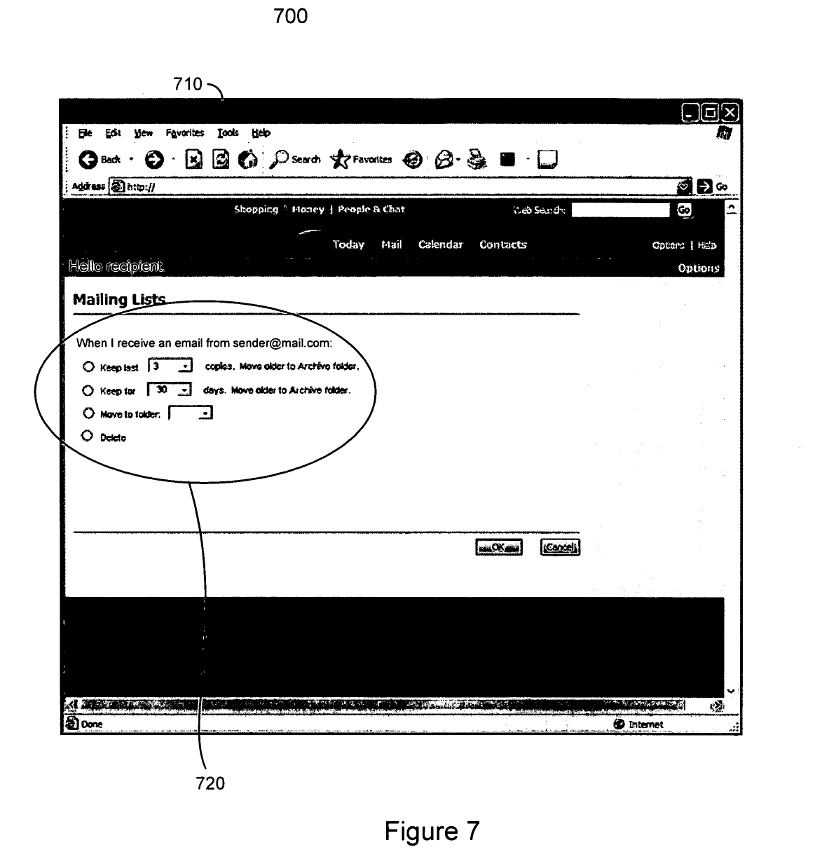

At step 550, a periodic email management interface is provided to the user at step 550. The periodic email management interface allows a user to provide input to configure how periodic emails (in this case, from the sender of the accessed email of step 510) are managed. An example of a email management interface is illustrated by interface 700 of FIG. 7. Interface 700 is discussed in more detail below.

Next, a determination is made as to whether input has been received that selects a rule to apply to the periodic email at step 560. In one embodiment, the input can be a selection of one or more rules. Examples of rules that can be applied to periodic emails include rules requiring routing of an email to a folder or other address, deleting an email upon receipt, deleting the email after a period of time, deleting emails from a sender in excess of a certain maximum number of allowed emails, or deleting emails once a maximum memory size has been reached for messages from the sender. In the latter case, the rule may specify the total size of messages to keep (e.g., 20 KB). If the combined size of all the emails exceeds the designated size, the oldest messages can be deleted until the remaining emails do not exceed the memory limit. Other rules can be applied as well and are considered within the scope of the present invention.

If no input is received selecting a rule at step 560, operation continues to step 585. If input selecting one or more rules is received at step 560, the selected rule is applied to the accessed email and the one or more rules are stored at step 570. In one embodiment, the one or more rules are stored with the periodic mail rules list. In another embodiment where mail processing rules are stored separately from the periodic mail rules list, the one or more rules are stored in a rule look-up table. The rule look-up table is associated with the recipient of the accessed email of step 510 and contains a list of rules to apply for a number of senders of periodic mail. If any rule is generated in response to input received by a user at step 560, the sender of the email is also added to the periodic mail rules list at step 570.

A prompt may be provided to allow a user to indicate whether the generated rules should be applied to stored emails at step 580. In one embodiment, the user may apply the most recent generated rule or all rules associated with the sender and recipient on stored emails. If input is received at step 590 indicating the rules should be applied, then the rules are applied to the current emails at step 595. This is discussed in more detail below. If input is received at step 590 indicating the rules should not be applied to stored emails, operation ends at step 585.

FIG. 6 illustrates one embodiment of an interface 600 for prompting a user to apply a periodic mailer rule as discussed above at step 530 of method 500. Interface 600 includes GUI 610 having content and a periodic email management query 620. In one embodiment, GUI 610 is a web browser providing a web page, but could be provided by a client email application or some other software. GUI 610 displays the content of an email identified as periodic. Message management query 620 indicates that the current email appears to be a periodic email and that a user can choose to automatically keep only recent copies of email from the sender. Query 620 is merely one example of an email management query that can be used to prompt action on a suspected periodic email. Other query messages can be generated and are deemed within the scope of the present invention.

FIG. 7 illustrates one embodiment of an interface 700 for generating a periodic mailing rule as discussed above at step 550 of method 500. Interface 700 includes a GUI 710. In one embodiment, GUI 710 is implemented as a web browser. In another embodiment, a GUI for generating a periodic mailing rule could be implemented as an interface provided by a client mail application. GUI 710 includes a periodic email rule interface 720. Periodic email interface 720 allows a user to configured rules by indicating whether emails received from the sender should be kept for a number of days, whether a maximum number of copies of a periodic email should be kept, whether the emails should be moved to a particular folder or whether the periodic email should be deleted. Other rules can be configured as well and are considered within the scope of the present invention.

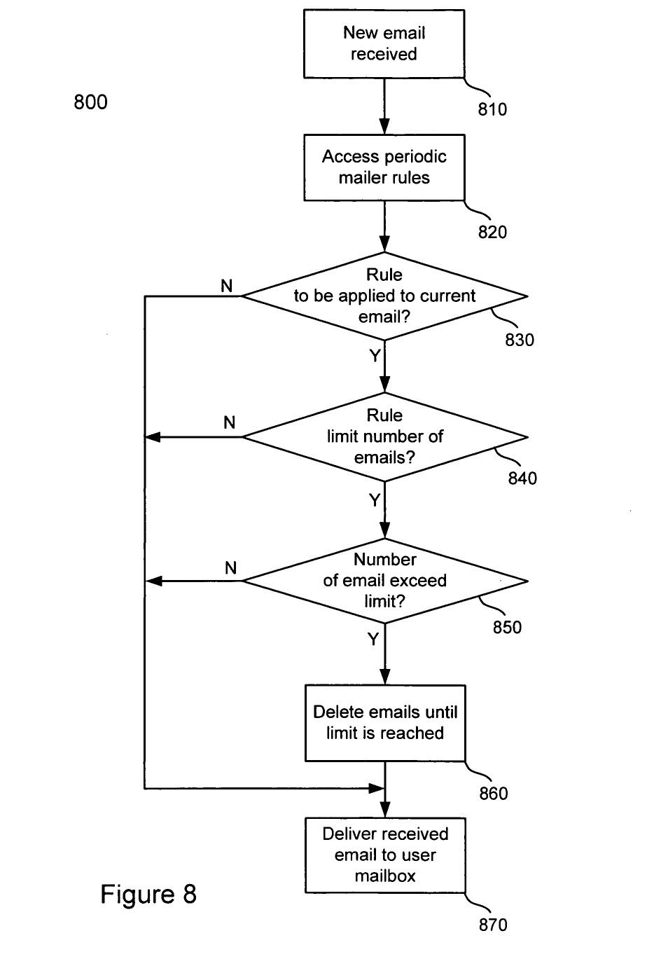

FIG. 8 illustrates one embodiment of a method 800 for applying a rule to an incoming email as discussed above at step 340 of FIG. 3. An email is received at step 810. A periodic mailer rules list is accessed at step 820. A determination is made regarding whether any rules should be applied to the received email at step 830. In one embodiment, the sender of the received email is checked against the periodic mail rules list accessed at step 820. If the sender is found on the periodic mail rules list, a look-up table is accessed to determine if any rules are to be applied to incoming messages from the sender. In another embodiment, if the sender is found on the periodic mail rules list, rules within the periodic mail rules list are accessed to determine if any rules should be applied to incoming messages from the sender. A rule is not applied to the received email if the sender is not on the periodic mail rules list or the rules do not affect incoming emails. For example, the only rule for a sender may be to delete emails thirty days after they are received. This rule would not affect incoming emails. If no rule should be applied to the received email, operation continues to step 870 where email is delivered to the user inbox. If a rule is to be applied to the email, operation continues to step 840. In another embodiment, the email may include content that specifies the rule to apply. For example, a sender may include content that specifies how long the email should be stored. In this case. the email will be deleted after the period of time specified in the email.

A determination is made as to whether the rule limits a number of emails to store from a sender at step 840. If the rule limits the maximum number of emails from a sender that should be stored, operation continues to step 850. If the rule does not limit the number of stored emails from the sender, operation continues to step 870.

At step 850, the system determines whether the number of emails stored for a sender exceed the maximum number of allowed emails. If the number of emails do not exceed the maximum number allowed for the sender, operation continues to step 870. If the number of emails exceeds the maximum number of emails allowed for the sender, operation continues to step 860.

Emails from the sender are deleted until the allowed number of emails remain at step 860. In some cases, the most recent email can be the most relevant email from a sender. This may be the case for time limited business opportunities, creditor account information, and account balance information. Thus, in one embodiment, emails from a sender are deleted in the order received. This leaves the most recent emails remaining in the user's account.

In other cases, the least important email from a sender may be the email smallest in size. Emails having a large size may have more information than smaller emails. This may be advantageous when multiple periodic emails are sent regarding monthly and weekly calendar events. A user may wish to keep a monthly calendar having more events and sent at the beginning of the month rather than a weekly calendar having a smaller file size and sent at the beginning of each week. Accordingly, in another embodiment, stored emails can be deleted based on the size of the email, with the smallest email deleted first. Emails can also be deleted in other orders than those described herein. Next, at step 870, the email received at step 810 is delivered to the user's mailbox.

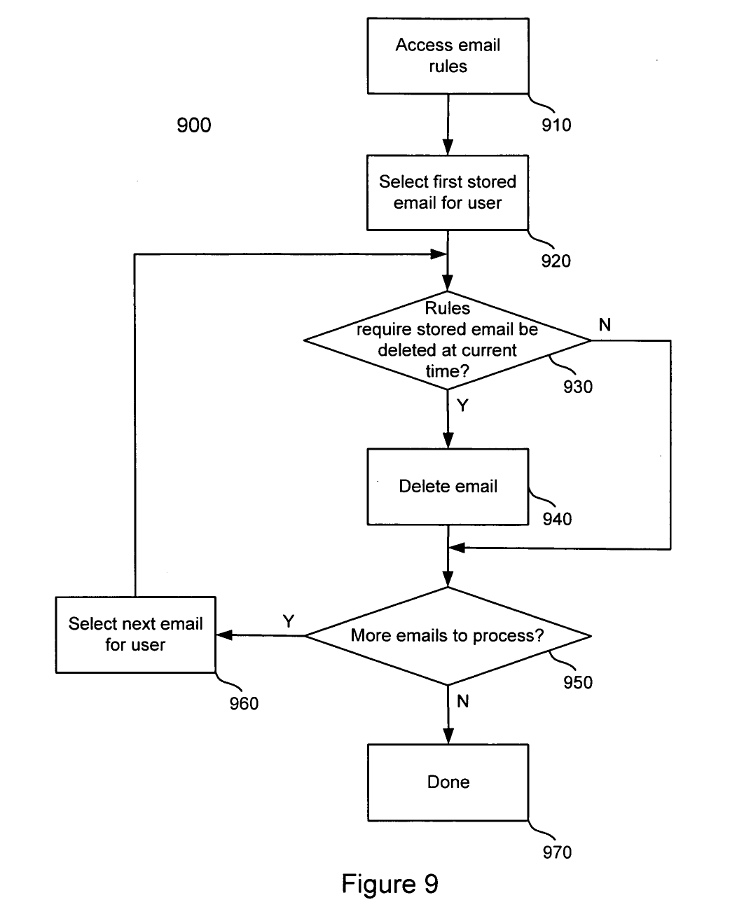

FIG. 9 illustrates one embodiment of a method 900 for applying rules to stored email as discussed above with respect to step 350 of method 300. Method 900 can be performed automatically as a scheduled task or in response to user input. In one embodiment, the task may repeatedly monitor a storage device within an email system, such as email store 142 of ESP 120. For example, the task may be added to the functionality of an ongoing janitor task that determines whether users of an email service have exceeded their mail capacity allowance.

At step 910, email rules are accessed. Accessing mail rules may include accessing a rule look-up table or accessing a periodic mail rule list. A first email stored in the users account is then selected at step 920. Next, a determination is made regarding whether the accessed email rules require the selected email to be deleted at step 930. For example, a rule may require an email from a sender be deleted every 14 days, every 30 days, every two months or at the expiration of some other time period. In this case, a determination is made as to whether the maximum storage period for the email has been exceeded. The email should be deleted if the maximum storage period has been exceeded. If the email should not be deleted, operation continues to step 950. If email should be deleted, the email is deleted at step 940.

Next, a determination is made as to whether more stored emails in the users account should be processed at step 950. If no further emails should be processed, operation ends at step 970. If more emails should be processed, the next stored email is selected at step 960 and operation continues to step 930.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for managing electronic messages, comprising:
accessing one or more electronic messages sent to a recipient from a sender;
determining the one or more electronic messages are periodic electronic messages; and
generating a rule for managing future electronic messages from the sender for the recipient, the rule based on the one or more electronic messages.

2. The method of claim 1, wherein the rule includes setting a maximum number of electronic messages to retain from the sender.

3. The method of claim 1, wherein the rule includes setting a maximum time period to retain electronic messages from the sender.

4. The method of claim 1, wherein the rule includes setting a maximum memory size allocated for messages received from the sender.

5. The method of claim 1, wherein said step of generating a rule includes:
generating a rule to process periodic electronic messages in response to receiving user input.

6. The method of claim 1, wherein said step of determining the one or more electronic messages are periodic electronic messages includes determining the average interval between the one or more electronic messages sent to the recipient from the sender.

7. The method of claim 1, further comprising:
accessing the rule in response to receiving a subsequent electronic message from the sender.

8. The method of claim 7, further comprising:
performing an action on the subsequent electronic message, the action based on the rule.

9. A system for processing periodic email, comprising:
a rule generator able to generate a rule for processing a periodic email received by a sender for a recipient, the rule generator deriving the rule from one or more emails received by the recipient from the sender; and
an rule application engine able to apply the rule to one or more periodic emails received by the recipient from a sender, said rule application engine connectively coupled to said rule generator.

10. The system of claim 9, said rule generator configured to delete one or more periodic emails received from the sender to maintain a specified maximum number of periodic emails from the sender.

11. The system of claim 9, further comprising:
a storage device having one or more emails received by a recipient, said email management device configured to delete periodic emails from the sender that have been stored in said storage device longer than a maximum period of time.

12. The system of claim 9, wherein said rule generator is a mail server, said rule generator and rule application engine are implemented as part of an email service provider system.

13. The system of claim 9, wherein said rule generator is a mail server, said rule generator and rule application engine are implemented as a client mail application.

14. The system of claim 9, wherein the rule includes deleting periodic emails to achieve an allowable number of periodic emails from the sender.

15. The system of claim 9, wherein the rule includes deleting periodic emails from the sender that have been stored longer than a maximum time period.

16. The system of claim 9, wherein said rule generator is configured to determine the average interval between the one or more electronic messages sent to the recipient from the sender.

17. One or more processor readable storage devices having processor readable code embodied on one or more said processor readable storage devices, said processor readable code for programming one or more processors to perform a method, the method comprising:
accessing an electronic message sent to a recipient from a sender;
identifying the electronic message as a periodic electronic message; and
generating a rule for processing future electronic messages from the sender for the recipient.

18. The one or more processor readable storage devices of claim 17, wherein the rule deletes one or more electronic messages identified as a periodic electronic message.

19. The one or more processor readable storage devices of claim 17, the method further comprising:
automatically accessing the rule in response to receiving a subsequent electronic message from the sender.

20. The one or more processor readable storage devices of claim 17, the method further comprising:
performing an action on an electronic message received from the sender, the action based on the rule and performed in response to receiving the subsequent electronic message.
